(19) United States
(12) Patent Application Publication
(10) Pub. No.: US 2016/0142667 A1
(43) Pub. Date: May 19, 2016

(54) IMAGE ACQUISITION DEVICE, IMAGE ACQUISITION METHOD AND RECORDING MEDIUM

(71) Applicant: CASIO COMPUTER CO., LTD., Tokyo (JP)

(72) Inventor: Tetsuya Hayashi, Hanno-shi (JP)

(21) Appl. No.: 14/858,130

(22) Filed: Sep. 18, 2015

(30) Foreign Application Priority Data
Nov. 13, 2014 (JP) 2014-230460

(51) Int. Cl. H04N 5/77; H04N 5/232; H04N 9/79; H04N 5/235

(52) U.S. Cl. CPC H04N 5/772; H04N 5/2353; H04N 5/23212; H04N 5/23293; H04N 9/79; H04N 2101/00

(57) ABSTRACT

A CPU sets an exposure value to conform to the entire imaging range acquired by an imaging section, and acquires an entire range image captured with this exposure value, at first acquisition timing for an entire-range-image movie. Also, the CPU sets an exposure value for a frame to conform to a main subject image or a predetermined area in the entire range image acquired by the imaging section, and acquires a cut-out image formed by trimming an image area including the main subject image or the predetermined area from an entire range image captured with this exposure value, at second acquisition timing for a partial-range-image movie.

### CROSS-REFERENCE TO RELATED APPLICATION

This application is based on and claims the benefit of priority from the prior Japanese Patent Application No. 2014-230460, filed Nov. 13, 2014, the entire contents of which are incorporated herein by reference.

### BACKGROUND OF THE INVENTION

1. Field of the Invention

The present invention relates to an image acquisition device, an image acquisition method and a recording medium.

2. Description of the Related Art

Conventionally, in a technology for generating a moving image by using images in a sequentially imaged range (hereinafter, referred to as entire range images) as frames, a technique has been proposed in which images of portions of a frame (hereinafter, referred to as partial range images) are trimmed, and another moving image is generated with these images as frames, as described in Japanese Patent Application Laid-Open (Kokai) Publication No. 2006-270550.

The object of the present invention is to enable images of different imaging ranges to be acquired under suitable imaging conditions.

### SUMMARY OF THE INVENTION

In accordance with one aspect of the present invention, there is provided an image acquisition device comprising: an imaging section; a first acquisition section which acquires a first image which corresponds to a first imaging range captured by the imaging section and whose imaging condition has been controlled to conform to the first imaging range; a second acquisition section which acquires a second image which corresponds to a second imaging range different from the first imaging range and whose imaging condition has been controlled to conform to the second imaging range, at second acquisition timing different from first acquisition timing of the first acquisition section; and a file generation section which generates a file from the first image and generates a file from the second image.

In accordance with another aspect of the present invention, there is provided an image acquisition method comprising: a first acquisition step of acquiring a first image which corresponds to a first imaging range of an imaging section and whose imaging condition has been controlled to conform to the first imaging range; a second acquisition step of acquiring a second image which corresponds to a second imaging range different from the first imaging range and whose imaging condition has been controlled to conform to the second imaging range, at second acquisition timing different from first acquisition timing of the first acquisition step; and a file generation step of generating a file from the first image and generating a file from the second image.

In accordance with another aspect of the present invention, there is provided a non-transitory computer-readable storage medium having a program stored thereon that is executable by a computer in an image acquisition device including an imaging section, the program being executable by the computer to actualize functions comprising: first acquisition processing for acquiring a first image which corresponds to a first imaging range captured by the imaging section and whose imaging condition has been controlled to conform to the first imaging range; second acquisition processing for acquiring a second image which corresponds to a second imaging range different from the first imaging range and whose imaging condition has been controlled to conform to the second imaging range, at second acquisition timing different from first acquisition timing of the first acquisition processing; and file generation processing for generating a file from the first image and generating a file from the second image.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing a functional structure of a digital camera 10 according to an embodiment of the present invention.

FIG. 2 is a block diagram showing a detailed structure of an imaging section 16 of the digital camera 10 according to the present embodiment.

FIG. 3 is a flowchart for describing operations of the digital camera 10 of the present embodiment.

FIG. 4 is a schematic view showing operations during continuous image capturing by the digital camera 10 of the present embodiment.

### DETAILED DESCRIPTION OF THE PREFERRED EMBODIMENTS

Hereafter, embodiments of the present invention are described with reference to the drawings.

### A. Structure of Embodiment

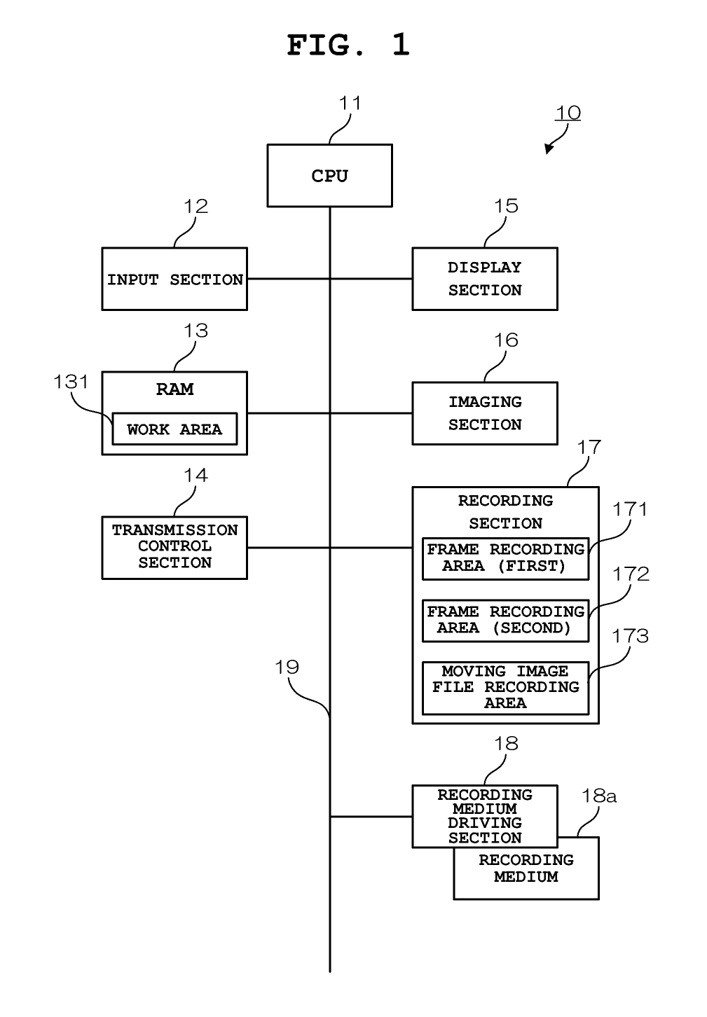

FIG. 1 is a block diagram showing the structure of a digital camera 10 according to an embodiment of the present invention.

In FIG. 1, the digital camera 10 is constituted by a CPU (Central Processing Unit) 11, an input section 12, a RAM (Random Access Memory) 13, a transmission control section 14, a display section 15, an imaging section 16, a recording section 17, a recording medium driving section 18, etc., and the respective sections are connected to each other by a bus 19.

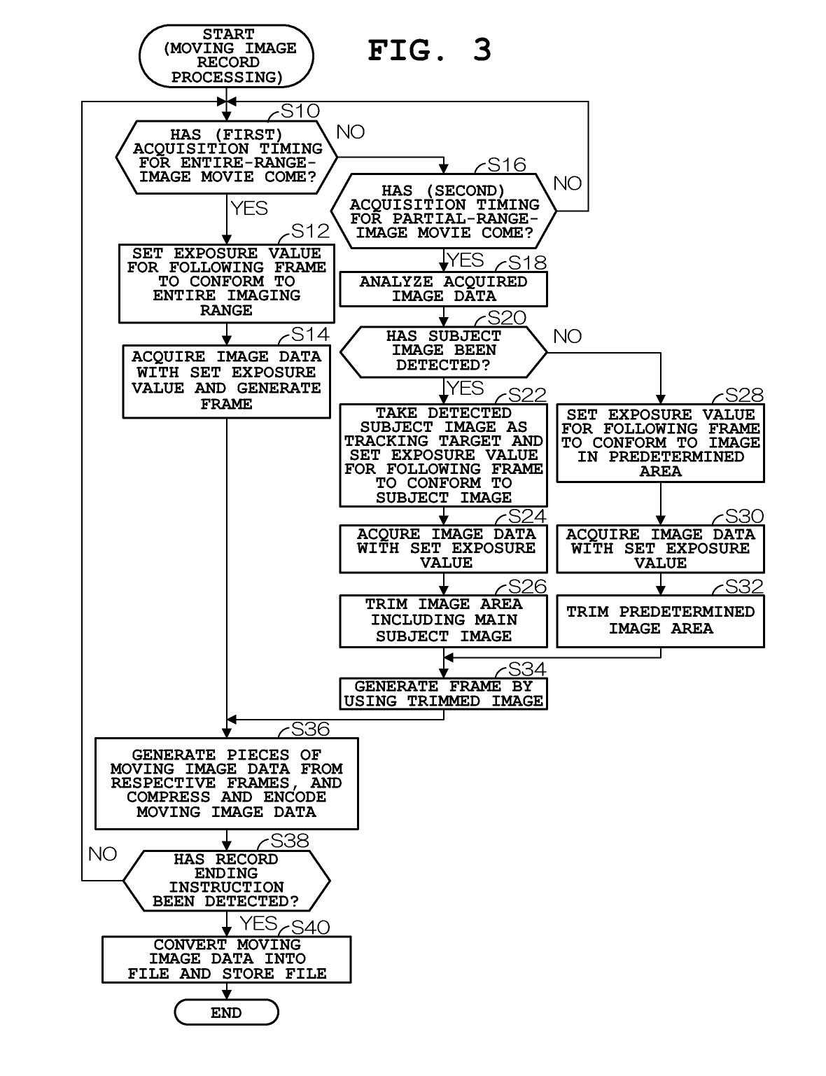

The CPU 11 reads out a system program stored in the recording section 17, develops the program in a work area 131 formed in the RAM 13, and controls the respective sections in accordance with the system program. Also, the CPU 11 reads out various processing programs including, for example, the main program and a moving image mode processing program stored in the recording section 17, and develops them on the work area 131 so that moving image record processing (see FIG. 3) described later is executed in accordance with the developed programs.

In the moving image record processing of the present embodiment, in continuous image capturing at a predetermined frame rate (for example, 60 fps), an exposure value for a frame is set conforming to the entirety of an image acquired by the imaging section 16, and an entire range image captured with this exposure value is acquired so that a frame is generated, at (first) acquisition timing for entire-range-image movies.

Also, in the moving image record processing of the present embodiment, in addition to the image capturing of the above-described entire range image, an exposure value for a frame is set conforming to a main subject image (or a predetermined area) in entire range image data acquired by the imaging section 16, and the image data of a partial range image formed by an image area (or a predetermined area) including the main subject image being trimmed (cut out) from an entire range image captured with this exposure value is acquired so that a frame is generated, at (second) acquisition timing for partial-range-image movies.

Moreover, in the moving image record processing of the present embodiment, a moving image (entire-range-image movie) is generated by using frames generated from entire range images, and another moving image (partial-range-image movie) is generated by using frames generated from partial range images acquired by trimming areas including a main subject image.

For example, in a case where continuous image capturing is performed at 60 fps, the (first) acquisition timing for acquiring image data for an entire-range-image movie is set to 1/30 per second (30 fps), and the (second) acquisition timing for acquiring image data for a partial-range-image movie is set to 1/30 per second (30 fps) which comes alternately with the frame acquisition timing for an entire-range-image movie. In the following descriptions, the (second) acquisition timing for acquiring image data for a partial-range-image movie comes immediately before and after the (first) acquisition timing for acquiring image data for an entire-range-image movie. However, the (second) acquisition timing for acquiring image data for a partial-range-image movie is not necessarily required to come immediately before and after the (first) acquisition timing for acquiring image data for an entire-range-image movie as long as it is different from the (first) acquisition timing for acquiring image data for an entire-range-image movie.

The input section 12 includes a power supply key, a shutter key, a cross key that is used to indicate longitudinal and lateral directions on the display screen of the display section 15 for moving cursor positions on the display screen or selecting various modes and image files, and a determination key arranged in the center of the cross key for setting currently selected contents, and outputs an operation signal in accordance with the operation of each key by the user to the CPU 11.

The RAM 13 constitutes a work area 131 that temporarily stores various programs to be executed by the CPU 11 and data related to these programs.

The transmission control section 14 is connected to an external electronic apparatus such as a personal computer by a communication cable or the like, and controls data transmission and reception to and from the external apparatus. Note that the connection with the external apparatus may be performed by a wireless connection using infrared rays, radio waves, or the like.

The display section 15 is constituted by a monitor such as an LCD (Liquid Crystal Display), and outputs an image to be captured, a captured image, a created moving image, or the like to the display screen in accordance with an instruction given by a display signal inputted from the CPU 11. The imaging section 16, which is constituted by an optical system such as lenses or the like, a CCD (Charge Coupled Device), and the like, images a photographic subject, and supplies it to the CPU 11 as a captured image.

The recording section 17, which is constituted by a non-volatile memory or the like such as a flash memory, records a system program for the digital camera 10, a main processing program that is executable on the system program, various processing programs including a moving image mode processing program, and data or the like processed by these programs.

The recording section 17 includes a (first) frame recording area 171, a (second) frame recording area 172, and a moving image file recording area 173. The (first) frame recording area 171 stores image data acquired by the imaging section 16 at the (first) acquisition timing for entire-range-image movies in moving image record processing described later, and the (second) frame recording area 172 stores image data acquired by the imaging section 16 at the (second) acquisition timing for partial-range-image movies in the moving image record processing described later. The moving image file recording area 173 stores a plurality of moving image files generated respectively from image data stored in the (first) frame recording area 171 and the (second) frame recording area 172.

The recording medium driving section 18 is a driving circuit for recording data in an attached recording medium 18a and for reading out recorded data for playback. As the recording medium 18a, various cards such as a smart medium (registered trademark), a memory stick (registered trademark), a compact flash (registered trademark), an SD (Secure Digital) card, a PC (Personal Computer) card, an IC (Integrated Circuit) card, MO (Magneto-Optic), and the like may be used, and a recording medium driving section that is suitable for one or a plurality of these various cards is provided.

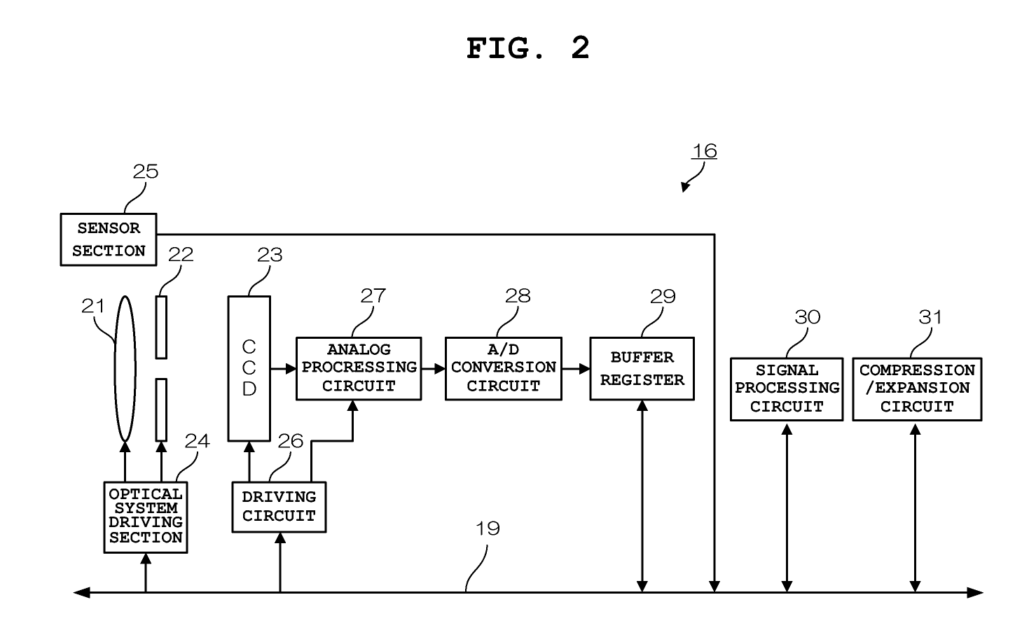

FIG. 2 is a block diagram showing a detailed structure of the imaging section 16 of the digital camera 10 according to the embodiment of the present invention. A subject image that has passed through the lens (imaging lens) 21 is formed on the CCD 23 via a diaphragm mechanism 22. The lens positions of the lens 21 and the diaphragm mechanism 22 are moved in accordance with a focused point value for focusing processing by an optical system driving section 24, and its diaphragm amount (F-number) is controlled so as to provide an appropriate exposure.

A sensor section 25 in FIG. 2 detects the movement of the lens 21 and the diaphragm of the diaphragm mechanism 22, and supplies the respective detection values to the CPU 11 via the bus 19. The sensor section 25 includes a range-finding sensor and a light quantity sensor. The optical system driving section 24 drives and controls the lens 21 and the diaphragm mechanism 22 in accordance with signals indicating the amount of movement of the lens 21 and the amount of diaphragm of the diaphragm mechanism 22 calculated by the CPU 11 based on the detection values.

When a subject image is formed, the CCD 23 accumulates a charge corresponding to an incident light quantity. This charge is sequentially read out by a driving pulse signal given by the driving circuit 26, and supplied to an analog processing circuit 27. The analog processing circuit 27 carries out various processes, such as color separation, gain adjustment, white balance adjustment, or the like. An A/D conversion circuit 28 in FIG. 2 converts a signal subjected to various processing to digital data, and a buffer register 29 stores digital image data (hereinafter, referred to as image data) supplied thereto via the A/D conversion circuit 28.

The signal processing circuit 30 converts image data stored in the buffer register 29 to a luminance signal and a color difference signal based on a control signal from the CPU 11, and the converted signal is displayed on the display section 15 shown in FIG. 1. The image data processed in the signal processing circuit 30 is compressed in a compression/expansion circuit 31 based on a control signal from the CPU 11, and recorded in the recording section 17 or the recording medium 18a shown in FIG. 1 via the bus 19.

### B. Operation of Embodiment

Next, the operation of the present embodiment is described.

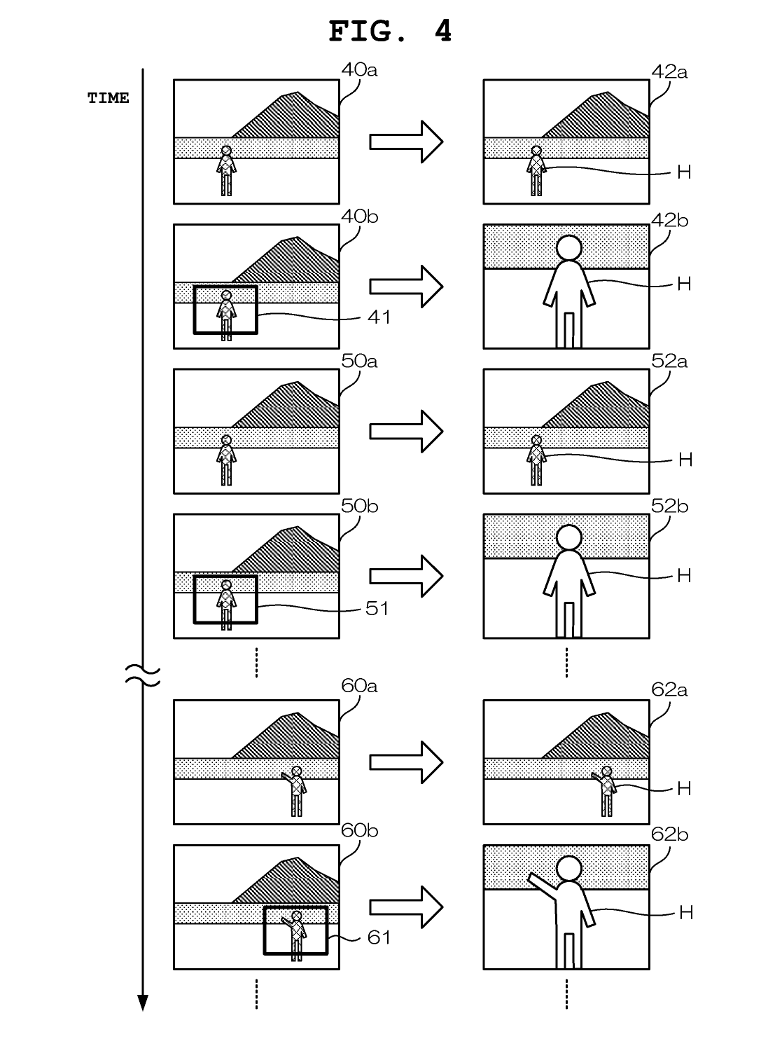

FIG. 3 is a flowchart for describing operations of the digital camera 10 of the present embodiment, and FIG. 4 is a schematic view showing operations of the digital camera 10 of the present embodiment at the time of image capturing.

When moving image record processing is started, the CPU 11 judges whether the (first) acquisition timing for acquiring image data for an entire-range-image movie has come (Step S10). For example, in the case of consecutive image capturing at 60 fps, the (first) acquisition timing for acquiring image data for an entire-range-image movie is set to 1/30 per second. Then, when judged that the (first) acquisition timing for acquiring image data for an entire-range-image movie has come (YES at Step S10), the CPU 11 sets an exposure value for the following frame to conform to the entire imaging range (Step S12). Subsequently, the CPU 11 acquires image data with the set exposure value by the imaging section 16 and generates a frame (Step S14). This frame is stored in the (first) frame recording area 171 of the recording section 17.

Next, the CPU 11 generates moving image data from the (first) frame stored in the (first) frame recording area 171 of the recording section 17, and compresses and encodes the data in the compression/expansion circuit 31 (Step S36). Subsequently, the CPU 11 judges whether a record ending instruction by a user operation has been detected (Step S38). When judged that no record ending instruction has been detected (NO at Step S38), the CPU 11 returns to Step S10, and again judges whether the acquisition timing has come.

Conversely, when judged that the (first) acquisition timing for an entire-range-image movie has not come (NO at Step S10), the CPU 11 judges whether the (second) acquisition timing for acquiring image data for a partial-range-image movie has come (Step S16). In this embodiment, the (second) acquisition timing for acquiring image data for a partial-range-image movie is set to come every 1/30 second immediately before and after the (first) acquisition timing for an entire-range-image movie. Then, when judged that the (second) acquisition timing for a partial-range-image movie has not come (NO at Step S16), the CPU 11 returns to Step S10, and again judges whether the acquisition timing has come.

Conversely, when judged that the (second) acquisition timing for a partial-range-image movie has come (YES at Step S16), the CPU 11 analyses image data acquired by the imaging section 16 (Step S18). Next, based on the result of the analysis, the CPU 11 judges whether a subject image has been detected (Step S20).

When judged that a subject image has been detected (YES at Step S20), the CPU 11 takes the detected subject image as a tracking target, and sets an exposure value for the following frame to conform to the subject image (Step S22). Subsequently, the CPU 11 acquires image data with the set exposure value by the imaging section 16 (Step S24), and trims an image area including the main subject image (Step S26). Then, the CPU 11 generates a frame by using the trimmed image (Step S34) This frame is stored in the (second) frame recording area 172 of the recording section 17.

Next, the CPU 11 generates moving image data from the (second) frame stored in the (second) frame recording area 172 of the recording section 17, and compresses and encodes the data in the compression/expansion circuit 31 (Step S36). Next, the CPU 11 judges whether a record ending instruction by a user operation has been detected (Step S38). When judged that no record ending instruction has been detected (NO at Step S38), the CPU 11 returns to Step S10, and again judges whether the acquisition timing has come.

At Step S20, when judged that no subject image has been detected (NO at Step S20), the CPU 11 sets an exposure value for the following frame to conform to an image of a predetermined area (Step S28). Next, the CPU 11 acquires an image with the set exposure value by the imaging section 16 (Step S30), and trims a predetermined image area therefrom (Step S32). Next, the CPU 11 generates a frame by using the trimmed image (Step S34). This frame is stored in the (second) frame recording area 172 of the recording section 17.

In this case as well, the CPU 11 generates moving image data from the (second) frame stored in the (second) frame recording area 172 of the recording section 17, and compresses and encodes the data in the compression/expansion circuit 31 (Step S36). Subsequently, the CPU 11 judges whether a record ending instruction by a user operation has been detected (Step S38). Then, when judged that no record ending instruction has been detected (NO at Step S38), the CPU 11 returns to Step S10, and again judges whether the acquisition timing has come.

Conversely, when judged that a record ending instruction by a user operation has been detected (YES at Step S38), the CPU 11 converts pieces of moving image data individually generated from respective (first and second) frames into files, and stores these moving image files in a moving image file recording area 173 (Step S40). Then, the processing is ended.

In the example shown in FIG. 4, at the (first) acquisition timings for acquiring image data for an entire-range-image movie, exposure values for following frames are set conforming to the entire areas of images 40a, 50a, . . . , and 60a, respectively, and image data 42a, 52a, . . . , and 62a captured with the set exposure values are stored in the (first) frame recording area 171. Then, one moving image file (30 fps) is generated from these image data 42a, 52a, . . . , and 62a. In this case, since the exposure values are set conforming to the entire areas of the images 40a, 50a, . . . , and 60a, the entire range images are captured under desired imaging conditions. However, a photographic subject H is captured in a dark state.

On the other hand, at the (second) acquisition timings for acquiring image data for a partial-range-image movie which occur immediately before and after the (first) acquisition timing for acquiring image data for an entire-range-image movie, exposure values for following frames are set conforming to the subject image while the subject image is being tracked, and image areas 41, 51 and 61 including the main subject image are trimmed from image data 40b, 50b, . . . , and 60b captured with the set exposure values. Subsequently, image data 42b, 52b, . . . , and 62b trimmed therefrom are stored in the (second) frame recording area 172. Then, from these image data 42b, 52b, . . . , and 62b, one moving image file (30 fps) is generated. In this case, since the exposure values are set conforming to the subject image, the subject H is captured under desired imaging conditions. That is, the subject H is captured in a comparatively bright state.

In the above-described embodiment, exposure values are set for image data for an entire-range-image movie and image data for a partial-range-image movie, respectively, and the pieces of image data are acquired, respectively. As a result of this configuration, a moving image can be generated not only under imaging conditions suitable for entire range images but also under imaging conditions suitable for a subject image included in the entire range image.

Also, in the above-described embodiment, the (first) acquisition timing for acquiring image data for an entire-range-image movie and the (second) acquisition timing for acquiring image data for a partial-range-image movie are different from each other. As a result of this configuration, exposure values can be set based on image data acquired at the respective acquisition timings.

Moreover, in the above-described embodiment, a subject image is detected from an image within a predetermined area and an exposure value is set based on the detected subject image. As a result of this configuration, a moving image can be generated under imaging conditions suitable for a subject image included in an entire range image.

Furthermore, in the above-described embodiment, images in a predetermined area are continuously acquired and a subject image is tracked by the subject image being continuously detected from the continuously acquired images in the predetermined area. As a result of this configuration, a moving image can be generated under imaging conditions suitable for a subject image included in an entire range image.

In the above-described embodiment, exposure values are set respectively for image data for an entire-range-image movie and image data for a partial-range-image movie. However, a configuration may be adopted in which the lens position (focusing value) of the lens 21 is also set respectively for image data for an entire-range-image movie and image data for a partial-range-image movie. In this configuration, not only a moving image focused on an entire image but also a moving image focused on a subject image included in the entire image can be generated.

Also, in the above-described embodiment, exposure values are set respectively for image data for an entire-range-image movie and image data for a partial-range-image movie. However, a configuration may be adopted in which adjustment values for adjusting the color gain of an image outputted from the CCD 23 are set respectively for image data for an entire-range-image movie and image data for a partial-range-image movie. In this configuration, not only a moving image having a color gain (white balance) suitable for an entire range image but also a moving image having a color gain (white balance) suitable for a subject image included in the entire range image can be generated.

Moreover, in the above-described embodiment, one image is acquired as image data for a partial-range-image movie. However, the present invention is not limited thereto, and a configuration may be adopted in which two or more images including different subject images or different areas are acquired.

While the present invention has been described with reference to the preferred embodiments, it is intended that the invention be not limited by any of the details of the description therein but includes all the embodiments which fall within the scope of the appended claims.

What is claimed is:

1. An image acquisition device comprising:
an imaging section;
a first acquisition section which acquires a first image which corresponds to a first imaging range captured by the imaging section and whose imaging condition has been controlled to conform to the first imaging range;
a second acquisition section which acquires a second image which corresponds to a second imaging range different from the first imaging range and whose imaging condition has been controlled to conform to the second imaging range, at second acquisition timing different from first acquisition timing of the first acquisition section; and
a file generation section which generates a file from the first image and generates a file from the second image.

2. The image acquisition device according to claim 1, further comprising:
a setting section which sets a first imaging condition or a second imaging condition based on an image captured before or after the first acquisition timing of the first acquisition section or the second acquisition timing of the second acquisition section,
wherein the imaging condition is controlled such that the first acquisition section acquires the image under the first imaging condition when the first imaging condition is set by the setting section, and the second acquisition section acquires the image under the second imaging condition when the second imaging condition is set by the setting section.

3. The image acquisition device according to claim 2, further comprising:
a third acquisition section which acquires an image for setting the first imaging condition and an image for setting the second imaging condition,
wherein acquisition timing for acquiring the image for setting the first imaging condition is different from acquisition timing for acquiring the image for setting the second imaging condition.

4. The image acquisition device according to claim 2, further comprising:
a detection section which detects a subject image from the second image acquired by the second acquisition section,
wherein the setting section, when setting the second imaging condition, sets the second imaging condition based on the subject image detected by the detection section.

5. The image acquisition device according to claim 4, wherein the imaging section sequentially performs image capturing,
wherein the second acquisition section sequentially acquires second images, and
wherein the detection section includes a tracking section which tracks the subject image by continuously detecting the subject image from the second images sequentially acquired by the second acquisition section.

6. The image acquisition device according to claim 1, wherein the imaging condition includes an exposure value that is set for the imaging section.

7. The image acquisition device according to claim 1, wherein the imaging section includes a focusing section, and
wherein the imaging condition includes a focusing value that is set for the focusing section.

8. The image acquisition device according to claim 1, wherein the imaging condition includes an adjusting value for adjusting a color gain of an image that is outputted from the imaging section.

9. The image acquisition device according to claim 1, wherein the first imaging range is an entire imaging range capable of being recorded by the imaging section, and the second imaging range is smaller than the first imaging range.

10. The image acquisition device according to claim 1, wherein the first acquisition section sequentially acquires first images,
wherein the second acquisition section sequentially acquires second images at each second acquisition timing different from the first acquisition timing of the first acquisition section, and
wherein the file generation section generates a first moving image file with the sequentially acquired first images as frames, and generates a second moving image file with the sequentially acquired second images as frames.

11. An image acquisition method comprising:
a first acquisition step of acquiring a first image which corresponds to a first imaging range of an imaging section and whose imaging condition has been controlled to conform to the first imaging range;
a second acquisition step of acquiring a second image which corresponds to a second imaging range different from the first imaging range and whose imaging condition has been controlled to conform to the second imaging range, at second acquisition timing different from first acquisition timing of the first acquisition step; and
a file generation step of generating a file from the first image and generating a file from the second image.

12. A non-transitory computer-readable storage medium having a program stored thereon that is executable by a computer in an image acquisition device including an imaging section, the program being executable by the computer to actualize functions comprising:
first acquisition processing for acquiring a first image which corresponds to a first imaging range captured by the imaging section and whose imaging condition has been controlled to conform to the first imaging range;
second acquisition processing for acquiring a second image which corresponds to a second imaging range different from the first imaging range and whose imaging condition has been controlled to conform to the second imaging range, at second acquisition timing different from first acquisition timing of the first acquisition processing; and
file generation processing for generating a file from the first image and generating a file from the second image.
